(19) United States
(12) Patent Application Publication
(10) Pub. No.: US 2017/0341844 A1
(43) Pub. Date: Nov. 30, 2017

(54) PACKAGING SYSTEM FOR COMPONENTS

(71) Applicant: GM GLOBAL TECHNOLOGY OPERATIONS LLC, Detroit, MI (US)

(72) Inventors: Johannes GEIS, Ruesselsheim (DE); Nils JOHANNSEN, Ruesselsheim (DE)

(73) Assignee: GM GLOBAL TECHNOLOGY OPERATIONS LLC, Detroit, MI (US)

(21) Appl. No.: 15/605,374

(22) Filed: May 25, 2017

(30) Foreign Application Priority Data
May 27, 2016 (DE) 102016006537.0

(51) Int. Cl. B65D 81/02; B65D 85/68; B65D 85/62; B29C 45/14; B29L 31/00

(52) U.S. Cl. CPC B65D 81/025; B65D 85/62; B29C 45/14; B65D 85/68; B29L 2031/712; B65D 2585/686

(57) ABSTRACT

A packaging system for packaging components includes a plurality of frames arranged on top of one another. A laminar structure is fixed to each of the frames. At least one component is arranged and held between two laminar structures—one laminar structure is fixed to one frame—supported by two frames, which forms a holding component of the packaging system.

### CROSS-REFERENCE TO RELATED APPLICATION

This application claims priority to German Patent Application No. 102016006537.0, filed May 27, 2016, which is incorporated herein by reference in its entirety.

### TECHNICAL FIELD

The present disclosure pertains to a packaging system for packaging components and to a method for producing a frame including a laminar structure fastened to the frame.

### BACKGROUND

In the motor vehicle industry, suppliers deliver a large variety of components to the manufacturers of motor vehicles. For these components of different shapes or geometries, which the suppliers deliver to the motor vehicle manufacturers, packaging is necessary, so that the components are not damaged during transport. Due to the fact, however, that the components have a different shape, it is thus necessary to produce packaging of a different geometry, which is adapted to the geometry of the components. Due to the fact that suppliers deliver a plurality of different components of different geometries to the manufacturers of the motor vehicles, it is thus necessary in an extensive and cost-intensive manner to correspondingly provide and produce different packaging. The manufacturers of the motor vehicles thereby provide this packaging to the suppliers. This packaging is, for example, two half shells, which each surround a component, and the inner side of the half shells are substantially embodied complementary to the geometry of the components. Packaging for components of different geometries is also required for many other technical fields outside of the automobile industry.

A packaging system for packaging an article, for example a tomato, is disclosed in GB 640,283. The article is arranged and held between two laminar structures and the two laminar structures are fastened to two frames. A laminar structure is thereby directly fixed to the frame and this laminar structure is additionally indirectly fixed to a further frame, because the other laminar structure is arranged between this laminar structure and the further frame. Several laminar structures are thereby arranged on top of one another.

### SUMMARY

The present disclosure provides a packaging system for packaging components and a method for producing a frame including a laminar structure, which is fastened to the frame, in the case of which components of a different shape and geometry can be packaged by the packaging system in a reliable and inexpensive manner and without damaging the component during the transport.

In an embodiment a packaging system for packaging components includes a plurality of frames arranged on top of one another, a plurality of laminar structures fixed to the frames, and at least one component is arranged and held between two laminar structures. At least one laminar structure is fixed, preferably directly, to only one frame, so that only one frame forms a holding component of the packaging system with the laminar structure. Theses holding components are arranged on top of one another and thus form a packaging system, and the components are arranged and held between the laminar structures. A frictional fixation of the laminar structure to the frame is not at hand. The laminar structures are thus fastened to the frames in a secure and reliable manner and the packaging system can thus be set up particularly quickly, in that the laminar structures, which are already fixed to the frames, need to only be placed on top of one another as holding component and a fixation of the laminar structures to the frame is thus not necessary during the setup of placing the holding components on top of one another.

In an additional embodiment, the laminar structure is fixed to the frame in a bonded and/or permanent manner. The laminar structures are thus fixed to the frame in a particularly reliable manner by the bonded and/or permanent fixation of the laminar structure to the frame. This in particular also provides for a tensile stress of the laminar structure due to the fact that the components bear on the laminar structure. In a supplementary embodiment, one edge area of the one laminar structure is surrounded by the frame, so that the edge area is fixed to the frame, in particular in a bonded manner.

In a further alternative, the entire circumferential edge area of the laminar structure is enclosed by the frame. Recesses are thus not present between the frame and the laminar structure, so that components bearing on the laminar structure cannot fall through recesses and/or openings. In a supplementary embodiment, the at least one laminar structure is fixed to the frame or to only one frame each, respectively. In the case of all holding components, at least one laminar structure is thus fixed to the only one frame.

The two laminar structures, between which at least one component is arranged and held, are preferably each located on top of one another without a bonded and/or without a positive locking connection. In particular a substance-to-substance bond thus does not exist between two laminar structures. For example, two laminar structures, which are located on top of one another, are not connected to one another in a bonded manner by heating.

In a supplementary embodiment, the respective laminar structure is fixed to the one frame each in such a manner that the laminar structure is fixed to the one frame under a tensile pre-loading without an arrangement of the at least one component on the laminar structure. After the production of the holding component or without an arrangement of a component on the laminar structure, respectively, the laminar structure is fixed to the frame with a tensile stress. In the case of an arrangement of a component between two laminar structures, the components are held in a frictional manner by the two laminar structures. The component has a larger vertical expansion than the distance between the two laminar structures on the two frames located on top of one another, in response to an elastic expansion of the laminar structures.

Advantageously, the frame is embodied in a substantially rectangular manner. In an additional embodiment, the frame is made, in particular exclusively, of plastic, preferably EPP. In a supplementary embodiment, the laminar structure is a flexible panel such as a textile, in particular a fabric and/or a woven fabric and/or a felt and/or latex sheet and/or leather sheet and/or rubber sheet or a combination thereof. On the one hand, a textile provides for the absorption of correspondingly large tensile stresses, because the components bear on the textile. On the other hand, the textile can prevent damages to the components, because the textile is arranged between the components, which are located on top of one another. In an additional embodiment, the laminar structure is a foil and/or a composite material of a textile and a foil.

Method according to the present disclosure for producing a frame including a laminar structure fixed to the frame as holding component for a packaging system. A laminar structure is provided by inserting or placing an edge area of the laminar structure into an injection molding tool or rigid foam EPP tool. Plastic is inserted into the injection molding tool or rigid foam EPP tool. The edge area of the laminar structure is over molded with plastic, which hardens so that the edge area of the laminar structure is fixed to the plastic in a bonded and/or permanent manner. The injection molding tool or rigid foam EPP tool is opened and the frame is removed with the laminar structure fixed to the frame.

Preferably, a plurality of laminar structures is provided and placed into the injection molding tool or rigid foam EPP tool and are subsequently over molded by the plastic, so that a plurality of laminar structures is only fixed to one frame each in a bonded manner. A plurality of laminar structures can thus also be fixed to only one frame each, but only one frame each is fixed to one laminar structure each.

In an additional embodiment, the laminar structure is fixed to the frame with a tensile pre-loading after the removal of the frame including the laminar structure. Advantageously, a textile or a laminar structure herein described is provided as the laminar structure. The at least one laminar structure is preferably placed into an open injection molding tool or rigid foam EPP tool and the injection molding tool or rigid foam EPP tool is subsequently closed. In a further embodiment, a plurality of laminar structures is fixed to only one frame each. Advantageously, no frame is embodied in vertical direction between the components, in particular between all components.

In a further embodiment, an inner frame and/or an inner reinforcing rib and/or an inner reinforcing web is embodied between the components in horizontal direction. In the case of a large outer frame, an inner frame and/or an inner reinforcing rib within a space, which is delimited by the outer frame, is also sensible for the additional reinforcement of the outer frame. An inner frame and/or an inner reinforcing rib and/or an inner reinforcing web is preferably embodied on one, for example rectangular or square, outer frame.

In a supplementary alternative, at least one component is arranged and held between two laminar structures, which are each arranged directly on top of one another, in the case of all laminar structures. In the packaging system, there are thus two laminar structures, which are arranged directly on top of one another and between which no component is arranged. No laminar structure is arranged between two laminar structures, which are arranged directly on top of one another.

In a further embodiment, the frame is made from a stiff and/or inelastic material. In an additional alternative, the laminar structure is formed so as to be flexible and/or elastic and/or of a flexible and/or elastic material. For example, the textile, in particular the fabric, includes elastane.

In a further embodiment, a positive locking connection geometry for positively fastening the frames, which are located on top of one another, is embodied on a frame each. The horizontal slipping of the frames relative to one another, can thus be prevented in a positive manner. In a supplementary alternative, a force, which is directed vertically downwards, is applied to the uppermost frame of the packaging system by a tie, strap, box or other means for the frictional fastening of the frames which are located on top of one another. The horizontal slipping of the frames relative to one another can thus be prevented in a frictional manner.

Advantageously, the plastic is thermoplastic plastic, in particular PP or EPP.

### BRIEF DESCRIPTION OF THE DRAWINGS

The present disclosure will hereinafter be described in conjunction with the following drawing figures, wherein like numerals denote like elements.

FIG. 1 shows a perspective view of a holding component including a frame and a laminar structure fixed to the frame;

FIG. 2 shows a longitudinal section of the holding component according to FIG. 1;

FIG. 3 shows a longitudinal section of a packaging system including a plurality of holding components arranged on top of one another; and

FIG. 4 shows a longitudinal section of an injection molding tool.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

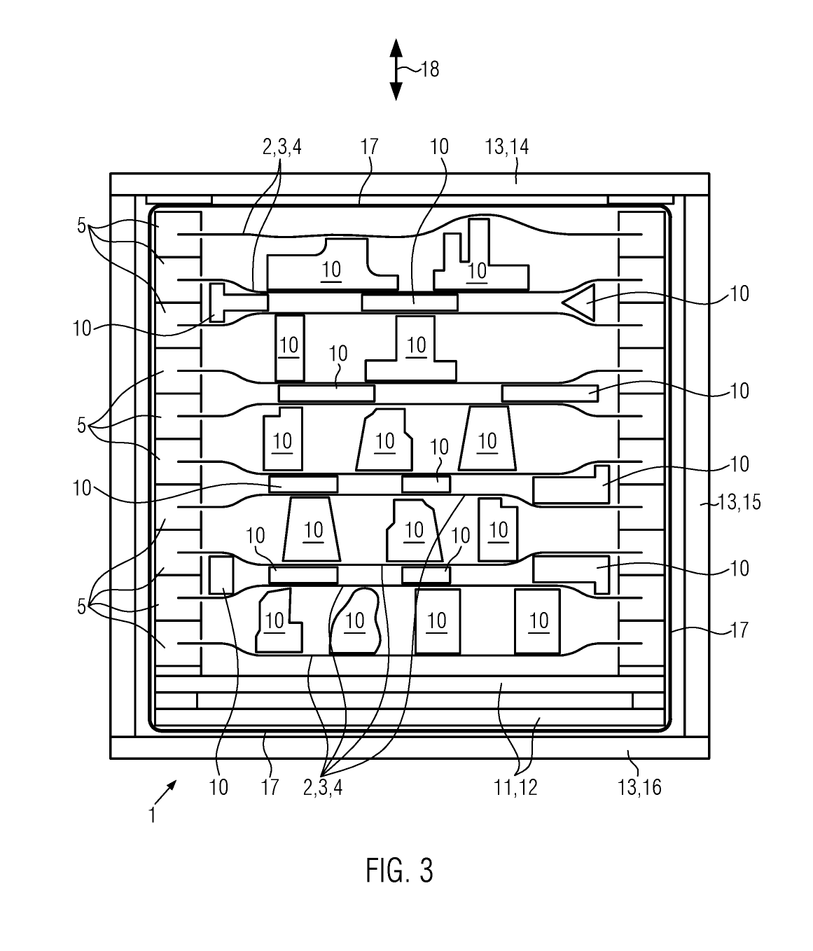

A packaging system 1 illustrated in FIG. 3 serves the purpose of packaging components 10. The components 10 are components, which a supplier delivers to the manufacturers of a motor vehicle, and the manufacturer of the motor vehicle uses these components 10, for example motor vehicle parts and/or machine elements, to join and manufacture a motor vehicle (not illustrated). The components 10 are thus packaged in the packaging system 1 during the transport from the supplier to the manufacturer of the motor vehicle.

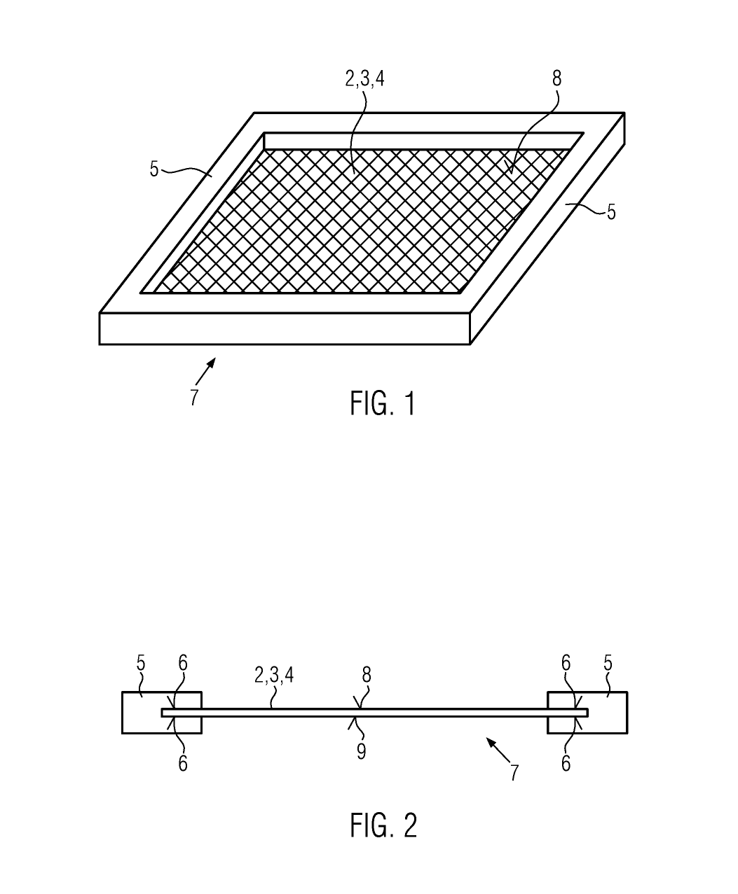

With reference now to FIGS. 1-4, the packaging system 1 includes a plurality of holding components 7 configured to be arranged or placed on top of one another, respectively, and stacked. Each holding component 7 includes a rectangular frame 5 of plastic and a laminar structure 2 such as a textile 3, in particular a fabric 4. Aside from cotton, the fabric 4 also includes elastane and is thus flexible and elastic. The laminar structure 2 is fixed to the frame 5 in a bonded and permanent manner. For this purpose, an edge area 6 of the laminar structure 2 is enclosed by the frame 5 and the edge area 6 is thereby enclosed by the frame 5 in a completely circumferential manner.

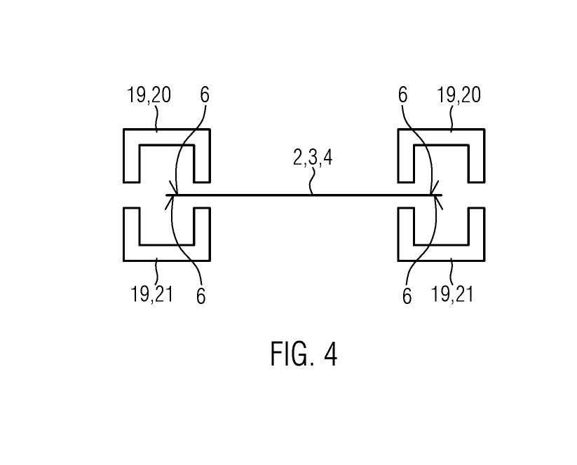

An injection molding tool or a rigid foam EPP injection molding tool, hereinafter referred to as a molding tool 19, may be used to produce the holding component 7. The molding tool 19 includes a first half 20 and a second half 21. FIG. 4 illustrates an open illustration of the molding tool in a longitudinal section prior to closing the two halves 20, 21. After the closing of the two halves 20, 21 of the molding tool 19, the edge area 6 of the laminar structure 2 is located inside the molding tool 19. The molding tool 19 additionally includes a non-illustrated slide, so that frames 5 including a different thickness can also be produced for use in the packaging system 1 in a simple manner with low production costs by the molding tool 19.

After the closing of the molding tool 19, thermoplastic plastic is introduced into an injection molding tool or EPP is introduced into the rigid foam EPP injection molding tool. The edge area 6 of the laminar structure 2 is thus fastened to the hardened plastic in a bonded manner after the hardening of the plastic. EPP is processed by a rigid foam EPP injection molding tool and other, non-EPP thermoplastic plastic is processed by an injection molding tool. At least one laminar structure 2 is fixed to only one frame 5 each, i.e., only one laminar structure 2 each is fixed to only one frame each or a plurality of laminar structures 2 (not illustrated) is fixed to only one frame each, respectively. One holding component 7 includes only one frame 5 each. No two frames 5 are fixed to only one laminar structure 2.

To transport the components 10 from the supplier to the manufacturer of the motor vehicle, a plurality of holding components 7 is placed on top of one another. The lowermost holding component 7 is thereby applied to a support 11, in particular a pallet 12. After the application of this lowermost holding component 7, the large components 10 are applied to a top side 8 of the laminar structure 2 of the lowermost holding component 7. A second holding component 7 is subsequently applied to this first holding component 7, when viewed from the bottom, and the two frames 5 are thereby located on top of one another according to the illustration in FIG. 3. On the underside, the large components 10 thus bear on the top side 8 of the laminar structure 2 and, on the top, on a bottom side 9 of another laminar structure 2 located thereabove. In a vertical direction 8, the vertical expansion of the large components 10 is larger than the vertical distance between the laminar structure 2 on the first and second holding component 7 without an arrangement of the large components 10, so that the laminar structures 2 thus bear on the large components 10 under a vertically oriented pressure. As a result, the laminar structures 2 are simultaneously also fixed to the frames 5 in horizontal direction under a tensile stress. In an advantageous manner, the components 10 are thus held between the two laminar structures 2 in a frictional manner, so that the large components 10 can thus not slip in horizontal direction. After the application of this second holding component 7, further smaller components 10 are applied to the laminar structure 2 again at this second holding component 7 and a further holding component 7 is applied subsequently.

Components 10 are thus in each case arranged and held between two laminar structures 2 directly abutting one another. This process is repeated, until a plurality of holding components 7 is arranged on top of one another and the components 10 are in each case arranged and held between two holding components 7, which are arranged on top of one another. Contrary to this, it is also possible to apply at least one component to only every second holding component 7, applied on top of one another, so that the components 10 are thus arranged only between every second pair of laminar structures 2, which are arranged on top of one another.

After all of the holding components 7 have been placed on top of one another and the components 10 are arranged and held between the laminar structures 2, a tie 17 or a constriction 17, respectively, is placed around the packaging system 1 and preferably also around the support 11, so that the constriction 17 or the tie 17, respectively, thus applies a force, which is directly vertically downwards, to the uppermost holding component 7. The holding components 7 are thus secured against a slipping relative to one another in a frictional manner. Optionally, corresponding positive locking geometries can additionally be embodied on the frames 5, so that two frames 5, which are located directly on top of one another, are held in a positive manner against a horizontal slipping of the two frames 5, which are located on top of one another. The packaging system 1 is furthermore also arranged inside an optional box 13. The box 13, as a transport box 13, includes a bottom wall 16, four side walls 15 and a cover 14 or a top wall 14, respectively. The geometry of the box 13 is thereby preferably also embodied to the effect that the top wall 14 applies a force, which is directed vertically downwards, onto the frame 5 of the uppermost holding component 7, and the frames 5, which are located on top of one another, are thus additionally secured in a positive manner against a horizontal slipping.

Taken as a whole, the packaging system 1 according to the present disclosure and the method according to the present disclosure for producing the frame 5 including the laminar structure 2 fixed to the frame 5 as the holding component 7 has significant advantages. The holding components 7 can be produced in a simple and inexpensive manner using the laminar structure 2 as the fabric 4 and the frame 5 of plastic, which is produced in an inexpensive manner by injection molding. The components 10 can be packaged in a secure and reliable manner between the holding components 7, which are stacked on top of one another, for the transport from the supplier to the manufacturer of the motor vehicle. The identical holding components 7 can also be used for components 10 including a different shape or geometry. In the case of a required packaging of components 10 of very different heights, frames 5 of a different thickness or vertical expansion, respectively, can be produced in an inexpensive manner by the molding tool 19. On the one hand, the packaging system 1 is thus highly flexible in the use for packaging components 10 of a different geometry and, on the other hand, the production is particularly inexpensive. The packaging system 1 can also be used in many other technical fields outside of the automobile industry, for example in electrical engineering, construction and mechanical engineering, for packaging components 10 of different shapes.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A packaging system for packaging components comprising:
a plurality of frames arranged on top of one another; and
a plurality of laminar structures fixed to the frames and configured to support at least one component between two laminar structures;
wherein one laminar structure each is fixed to only one frame each, such that one frame each forms a holding component each of the packaging system with the one laminar structure each and the holding components are arranged on top of one another.

17. The packaging system according to claim 16, wherein for each of the plurality of frames only one laminar structure is affixed thereto in permanent manner.

18. The packaging system according to claim 17, wherein an edge area of the laminar structure is surrounded by frame so that the edge area is fixed to the frame in a bonded manner.

19. The packaging system according to claim 18, wherein the edge area comprising a circumferential edge area of the laminar structure enclosed by the frame.

20. The packaging system according to claim 18, wherein the laminar structure is under a tensile pre-loading without an arrangement of the at least one component thereon.

21. The packaging system according to claim 16, further comprising a constriction member securing the holding components in a stacked arrangement.

22. The packaging system according to claim 16, wherein the constriction is selected from the group consisting of a tie, a strap and a box.

23. The packaging system according to claim 16, wherein each of the plurality of frames comprises a substantially rectangular frame.

24. The packaging system according to claim 16, wherein each of the plurality of frames comprises a plastic frame.

25. The packaging system according to claim 16, wherein each of the plurality of laminar structures comprise a flexible panel.

26. The packaging system according to claim 25, wherein the flexible panel is selected from the group consisting of a fabric, a woven fabric, a felt, a latex sheet, a leather sheet, a rubber sheet or a combination thereof.

27. The packaging system according to claim 25, wherein the flexible sheet comprises a foil.

28. A packaging system for packaging components comprising:
a first holding component including a first plastic frame having a first interior opening and a first flexible panel fixed to the first frame under a tensile pre-loading and extending in the first interior opening;
a second holding component including a second plastic frame having a second interior opening and a second flexible panel fixed to the second frame under a tensile pre-loading and extending in the second interior opening;
wherein the first and second holding components are arranged in a stacked configuration to define a packaging space between the first and second laminar structures and circumscribed by the first and second frames.

29. The packaging system according to claim 28, further comprising a constriction member securing the holding components in a stacked arrangement.

30. The packaging system according to claim 29, wherein the constriction member is selected from the group consisting of a tie, a strap and a box.

31. The packaging system according to claim 28, further comprising:
a third holding component including a third plastic frame having a third interior opening and a third flexible panel fixed to the third frame under a tensile pre-loading and extending in the third interior opening;
wherein the second and third holding components are arranged in a stacked configuration on top of the first holding component to define a second packaging space between the second and third flexible panels and circumscribed by the second and third frames.

32. A method for producing a frame having a laminar structure fixed thereto as a holding component for a packaging system comprising:
providing a laminar structure;
placing an edge of the laminar structure into a molding tool;
inserting plastic into the molding tool;
over molding the edge area of the laminar structure with plastic;
hardening the plastic such that the edge area of the laminar structure is fixed to the plastic in a permanent manner;
opening the molding tool; and
removing the frame with the laminar structure fixed thereto.

33. The method according to claim 32, further comprising pre-tensioning the laminar structure when the edge of the laminar structure is placed into the molding tool.

34. The method according to claim 32, wherein providing a laminar structure comprises providing a flexible panel.
